(19) United States
(12) Patent Application Publication
(10) Pub. No.: US 2001/0046363 A1
(43) Pub. Date: Nov. 29, 2001

(54) Variable optical attenuators and optical shutters using a coupling layer in proximity to an optical waveguide (II)

(76) Inventors: Ken G. Purchase, Mountain View, CA (US); Anthony J. Ticknor, Cupertino, CA (US); John T. Kenney, Palo Alto, CA (US)

Correspondence Address: Johney U. Han, Morrison & Foerster LLP, 755 Page Mill Road, Palo Alto, CA, 94304-1018, US

(21) Appl. No.: 09/788,046

(22) Filed: Feb. 16, 2001

Related U.S. Application Data
(60) Provisional application No. 60/187,233, filed on Mar. 3, 2000.

(51) Int. Cl. G02B 6/26

(52) U.S. Cl. 385/140; 385/50; 385/141

(57) ABSTRACT

A controllable variable optical attenuator for attenuating an optical signal is described herein. The attenuator has an optical waveguide made from similar waveguide core and cladding materials and a coupling layer in close proximity to the waveguide which is configured to provide a difference between the refractive index of the coupling layer in proximity to the waveguide and the effective index of the waveguide. The index of the waveguide can be modified such that if the refractive index of the coupling layer is substantially lower than the effective index of the waveguide, minimal attenuation occurs to the light in the waveguide. Furthermore, if the refractive index of the coupling layer is substantially greater than the effective index of the waveguide, light is coupled into the coupling layer out of the waveguide to attenuate the optical signal. The amount of attenuation varies smoothly between these maximum and minimum values.

### CROSS-REFERENCE TO RELATED APPLICATIONS

This application claims the benefit of priority to co-pending U.S. Provisional Patent Application Serial No. 60/187,233, entitled “VARIABLE OPTICAL ATTENUATORS AND OPTICAL SHUTTERS USING A COUPLING LAYER IN PROXIMITY TO AN OPTICAL WAVEGUIDE” filed Mar. 3, 2000, which is incorporated herein by reference in its entirety.

### TECHNICAL FIELD

This invention relates generally to optical waveguide-based devices including dynamically programmable optical attenuators, optical shutters, and optical switches with high extinction of unwanted optical leakage. In particular, this invention uses coupling of light from a waveguide to a polymer coupling layer in contact with that waveguide to dynamically modulate the intensity of light in the waveguide mode. Application of the invention facilitates the implementation of continuously-variable optical attenuators, optical shutters, and optical switches in an integrated photonic circuit.

### BACKGROUND OF THE INVENTION

Variable optical attenuators (VOA's) are used to adjust the signal levels between components of a fiber optic communication system, where optical signal power must be managed carefully. Currently a VOA is an optical device that can be inserted by splicing or using connectors into a fiber optic system, and reduces the intensity of the light in the fiber. A dynamically programmable VOA is capable of varying the amount of attenuation in response to a control signal.

A key performance issue in the practical application of optical devices is the efficiency of the device in transporting the optical energy of the signal. This performance is characterized in terms of the fraction of energy lost from the signal passing through the device, expressed as “loss” or “attenuation” in units of decibels (dB) or “loss rate” or “attenuation rate” in units of dB/cm. The attenuation of a variable attenuator in its least-attenuating state is defined as the “insertion loss” of the device, and the additional amount of attenuation achievable between that insertion loss and the maximum designed attenuation is defined as the “dynamic range.” Desirable insertion loss is near zero, and desirable dynamic range is from 10 dB to 50 dB and sometimes greater, depending on the intended use of the device. Another key performance issue is the “polarization dependent loss” (PDL). This quantity is the difference between the maximum loss and minimum loss attained when measured for all input polarizations of light. For most variable attenuators it is desirable to minimize PDL, typically below 0.5 dB throughout the attenuation range.

Most commercially-available variable attenuators on the market are mechanical, relying on the movement of an optical fibers, mirrors, prisms, graduated neutral density filters and the like to achieve attenuation. Such approaches are prone to mechanical failure, and are often not looked upon favorably by fiber optic system designers.

Another type of attenuator uses an optical fiber with part of the cladding removed, and in contact with a polymer material. It is described in U.S. Pat. No. 5,966,493, incorporated by reference herein. This attenuator uses thermal effects to vary the degree of attenuation. With both this discrete fiber approach and the mechanical approaches mentioned above, substantial cost savings are not achieved when multiple attenuators are integrated into one package, or when they are integrated with other optical devices in a single package. Further, the use of optical fibers limits the types of devices that can be formed on the same substrate. In essence, the attenuator described in the '493 patent is a discrete component that is connected to other discrete components via its fiber. It is not integrated with other devices on the same substrate.

Photonic devices for optical network management and wavelength multiplexing and demultiplexing applications have been extensively researched for a number of years. A significant class of such devices is commonly called “planar lightwave circuits” or “planar lightwave chips” or just PLC's. PLC's comprise technologies wherein complex optical components and networks are disposed monolithically within a stack or stacks of optical thin films supported by a common mechanical substrate such as a semiconductor or glass wafer. PLC's are typically designed to provide specific transport or routing functions for use within fiberoptic communications networks. These networks are distributed over a multitude of geographically dispersed terminations and commonly include transport between terminations via single-mode optical fiber. For a device in such a network to provide transparent management of the optical signals it must maintain the single-mode nature of the optical signal. As such, the PLC's are commonly, though not strictly, based on configurations of single-mode waveguides. Since optical signals do not require return paths, these waveguide configurations do not typically conform to the classic definition of “circuits”, but due to their physical and functional resemblance to electronic circuits, the waveguide systems are also often referred to as circuits.

The standard family of materials for PLC's, widely demonstrated to have superior loss characteristics, is based on silicon dioxide (SiO₂), commonly called silica. The silica stack includes layers that may be pure silica as well as layers that may be doped with other elements such as Boron, Phosphorous, Germanium, or other elements or materials. The doping is done to control index-of-refraction and other necessary physical properties of the layers. Silica, including doped silica, as well as a few less commonly used oxides of other elements, are commonly also referred to collectively as “oxides.” Furthermore, although technically the term “glass” refers to a state of matter that can be achieved by a broad spectrum of materials, it is common for “glass” to be taken to mean a clear, non crystalline material, typically SiO₂ based. It is therefore also common to hear of oxide waveguides being referred to as “glass” waveguides. Subsequently, the moniker “silica” is used to refer to those silicon oxide materials suitable for making waveguides or other integrated photonic devices. It is important to note that in the context of this invention, other waveguide materials, such as lithium niobate, spin-on glasses, silicon, siliconoxynitride, or polymers, are also appropriate.

There is a need for more reliable optical attenuators, and especially attenuators that can be formed as part of a PLC without having to interconnect the attenuators with other components via optical fiber. The invention provides such optical attenuators.

### SUMMARY OF THE INVENTION

In this invention, a device is described that is comprised of a waveguide and a coupling layer composed of different materials with different thermal properties. Varying amounts of heat are applied to the structure to control the attenuation rate. These attenuators can be made in arrays and integrated with other optical devices on a single substrate such that substantial cost savings are achieved over connecting an equal number of discrete devices.

In one embodiment of the invention, the device consists of a standard planar waveguide such as silica for low loss, and a coupling layer of changeable refractive index, usually consisting of polymer, in contact with the waveguide. Light is launched from an optical fiber into the core of the waveguide, and is collected from the waveguide core at the output into another optical fiber. The coupling layer is a region of adjustable refractive index and is positioned sufficiently close to the core of the waveguide layer that, if the refractive index of the coupling layer is sufficiently above the effective index of the waveguide mode, light is strongly coupled out of the waveguide into the coupling layer, thereby attenuating the signal. If the refractive index of the coupling layer is sufficiently below the effective index of the waveguide mode, light is not coupled out of the waveguide, and thus attenuation is low. When the refractive index of the coupling layer is approximately equal to the effective index of the waveguide mode, the attenuation rate varies, increasing as the coupling layer refractive index increases. Thus the attenuation rate depends on the refractive index of the coupling layer relative to the effective index of the waveguide core. The attenuation is a function of this attenuation rate and the length of the attenuator.

In the preferred embodiment of the device, thermal effects are used to control the index of the coupling layer relative to that of the waveguide layer. The thermal response of the index of refraction of the waveguide material differs from that of the coupling layer, and thus heat input can be used to control the refractive index of the coupling layer with respect to the effective index of the waveguide mode. To use this effect, heaters in the form of thin-film electrical resistors apply heat to the device, and the amount of heat applied is varied to control the amount of attenuation.

One advantage of planar waveguide variable attenuators over mechanical, fiber, and other variable attenuators is that planar waveguide attenuators can be created as groups or arrays of attenuators on a single substrate, and/or can be combined with other optical devices such as switches, wavelength division multiplexers, or optical power taps. This offers both cost and size advantages over pluralities of single attenuators and attenuators connected via fiber to other devices.

Commercially available planar waveguide variable attenuators typically have a maximum dynamic range of about 30 dB, with a PDL of about 0.5 dB at about 15 dB attenuation. The device described herein can be made to have dynamic range from a few dB to 50 dB or more. Also this invention can potentially achieve a PDL of typically less than 0.5 dB throughout a 15 dB dynamic range.

In one embodiment of this device, a single attenuator is attached to a single input and a single output optical fiber. In another embodiment, a plurality of such attenuators, each with its own input and output fiber, are combined in a single package and used as an array. Each attenuator can be controlled independently through its own heater. The plurality of attenuators are formed either by forming individual attenuators on separate substrates and adhering the plurality together (such as on a common substrate or by adhering adjoining edges of individual attenuators to form an array) or by fabricating the plurality on a single substrate, in the manner described below for an individual attenuator.

A waveguide attenuator of the invention may include additional structural features. For example, a waveguide attenuator of the invention may have input and output waveguides formed as part of the attenuator of sufficient length that the stimulus used to adjust the degree of attenuation (e.g. heat) is isolated from other optical components to which the attenuator is optically connected, so that the stimulus does not materially affect the operation of the adjacent components. The attenuator may also or instead have a well that diverges from the waveguide at its ends, so that the optical mode experiences a gradual transition from non-attenuation to attenuation as is more fully discussed below. The attenuator may also or instead be comprised of two attenuators positioned serially to one another so that the optical signal passes through one attenuator and then the other with a polarization rotator or filter mounted between the filters to provide equal attenuation of both TE and TM modes when the attenuator is formed of a birefringent material. An attenuator of this invention may have any or all of these features in combination.

In more complex embodiments of the device, the waveguide attenuator is combined with other devices on a single substrate. Such other devices can include, but are not limited to, optical switches, optical wavelength multiplexers or demultiplexers, or optical taps, which split off a fixed fraction of the light for monitoring before entering the attenuator, after leaving the attenuator, or both before and after the attenuator. Practically any number and variety of these devices can be combined in arrays.

Among other factors, this invention is based on the technical finding that:

A hybrid-material integrated photonic device; the majority of which is silica or a similar low-loss planar waveguide device, and;

Which is combined with a thermo-optic polymer or other suitable material as a coupling layer having different thermal properties from the waveguide materials;

Can, simultaneously:

Create a variable degree of attenuation that is controlled by heat input;

With very low polarization dependent loss; and/or

With a wide dynamic range.

Further, this invention can be used to provide improvements in the isolation of optical waveguide switches when integrated with these devices. These and other technical findings and advantages are apparent from the discussion herein.

### BRIEF DESCRIPTION OF THE DRAWINGS

FIG. 1 is a cross-sectional view of a basic variable attenuator consisting of a waveguide on a substrate, with thin-film metal heaters and a coupling layer above the waveguide.

FIG. 2a is a cross-sectional view of an attenuator in which a well is etched into the upper cladding of a waveguide and filled with the coupling layer material.

FIG. 2b is a cross-sectional view of an attenuator having multiple wells etched into the upper cladding of a waveguide and filled with the coupling layer material.

FIGS. 3a-3d are overhead views of variable attenuators in which a well is etched into the upper cladding above a waveguide, and the well and/or waveguide vary in geometry along the length of the device. FIG. 3a shows an attenuator consisting of a rectangular well above a straight waveguide, connected to unattenuating waveguide sections at each end. FIG. 3b shows an attenuator similar to that in FIG. 3a in which the well bends away from the waveguide at the edges. FIG. 3c shows a curved waveguide with a well that follows the curvature of the waveguide and uses a double heater for operation. FIG. 3d shows a curved waveguide with a well that is offset laterally from the position of the waveguide, and uses a single heater for operation.

FIG. 4 is a cross-sectional view of an attenuator in which a wide well is placed asymmetrically over a waveguide and a single resistive metal heater is used.

FIG. 5 is a cross-sectional view of an attenuator similar to the attenuator of FIG. 1 with the addition of a high-index layer above the coupling layer.

FIG. 6 is a cross-sectional view of an attenuator similar to the attenuator of FIG. 2a with the addition of high-index layers on either side of the well.

FIG. 7 is a representation of a device consisting of two variable attenuators joined by a section of non-attenuating waveguide, into which a waveplate is inserted.

FIGS. 8a through 8c are cross-sectional views of attenuators consisting of a polymer waveguide on a silica substrate with resistive metal heaters. FIG. 8a depicts a waveguide with polymer core, upper cladding, and lower cladding on a silica substrate. FIG. 8b depicts a waveguide with polymer core and upper cladding on a silica substrate. FIG. 8c depicts a waveguide with a polymer core within a well etched in the silica substrate, and a polymer upper cladding.

FIG. 9 is an overhead view of a device consisting of a variable attenuator and a power tap on one substrate

FIG. 10 is an overhead view of a 1×2 optical switch integrated with two variable attenuators used as optical shutters on a single substrate.

FIG. 11a is an overhead view of an array of variable attenuators placed between an arrayed waveguide grating (AWG) wavelength demultiplexer and an AWG wavelength multiplexer.

FIG. 11b is an overhead view of a monolithically integrated variable optical attenuator array having multiple input waveguides and multiple corresponding output waveguides.

FIGS. 12a through 12c are cross-sectional views of variable optical attenuators in which the coupling layer comes in direct contact with the waveguide core. FIG. 12a depicts a silica lower cladding and waveguide core with the coupling layer forming the upper cladding. FIG. 12b depicts a silica lower cladding and waveguide core with a silica cladding on the sides, and a coupling layer directly above the waveguide core and side cladding. FIG. 12c is a cross-sectional view of an attenuator in which a well is etched into the upper cladding of a waveguide and filled with the coupling layer material that comes in contact with the waveguide core.

FIG. 13 is an example of a plot showing the relationship of attenuation to refractive index, temperature change, and power.

### DETAILED DESCRIPTION OF THE INVENTION

Several embodiments are discussed below and with reference to the attached drawings. These descriptions and drawings are for explanatory purposes and do not exhaustively represent all combinations of waveguide, coupling layer, and material configurations provided by this invention. Those skilled in the art will readily appreciate that many other variations could be derived originating from these descriptions and cited technical findings without further invention. For instance, extension of the attenuator principles disclosed herein may be possible to such fields as MEMS and microfluidics. The below-described examples embody certain principles of the invention that are described above and herein, but the examples are not to be interpreted as limiting the scope of the claims to the specific examples described herein. Instead, the claims are to be given their broadest reasonable interpretation in view of the description herein, the prior art, and the knowledge of one of ordinary skill in this field. Attenuation as described herein relates to the fraction of energy lost from a signal passing through a device, as discussed in detail above, as opposed to a complete loss of energy during signal transfer. An attenuator may also be configured to act as a shutter in order to prevent an optical signal from being transmitted, i.e., the attenuator may not only attenuate, but may also act as a shutter.

The invention described herein is based on the combination of a PLC waveguide with a polymer material. In contrast to the inorganic waveguide materials, many optical polymers have a magnitude of the thermo-optic response that is 10-20 times greater (or more) than silica and their thermal conductivity is around 1/10^{th} that of silica. However, waveguides made in polymers usually have significantly higher optical loss rates than good silica waveguides. Consequently, as a rule optical polymers are excellent materials for making small, active photonic structures, but introduce performance penalties in loss when also used as the photonic interconnect between devices and to provide the chip's optical input and output terminations. Conversely, silica is an ideal interconnect medium on photonic circuits but makes for poor active devices.

Optical polymers are excellent candidates for active materials and are a particularly rich class of materials for thermo-optic applications. A polymer would be selected to provide the desired refractive index at desired upper and lower operating temperatures for a device. There are numerous suitable polymeric materials including, but not limited to, optical grades of polyacrylates, polymethacrylates, polysilicone, polyimide, epoxy, polyurethane, polyolefin, polycarbonate, polyamides, polyesters, etc. In addition, a variety of blends or copolymers are suitable for this invention. Examples are acrylate/methacrylates, acrylic/silicones, epoxy/urethanes, amide/imides, etc. Many others polymers and related materials have also been demonstrated as thermo-optic waveguide materials and, for the purposes of this invention, exhibit very similar behaviors.

The operation of this invention is based on changing the refractive index of a coupling layer relative to the effective index of the nearby waveguide mode. This function is achieved based on the phenomena that certain stimuli applied to a material will change the magnitude of the refractive index of that material. Typically-used stimuli for changing the refractive index are electric field (electro-optic), heat (thermo-optic), or dynamic stress (acousto-optic). Less commonly, other effects such as piezo-optic, static-stress, photo-refractive, index changes in liquid crystals or liquid crystal polymers, etc., are employed in waveguide applications. In the current state-of-the-art, thermo-optics is being accepted for the broadest range of applications and can provide a more predictable response to the randomly varying polarization of an optical signal. These stimuli may be applied to the material to change the magnitude of the refractive index by any number of methods. Some methods may include applying the stimulus via a contact pad attached to, e.g., a power source, electric generator, or some pressure-inducing device such as a hydraulic or pneumatic apparatus or piston. As such, discussions in this application will focus on thermo-optics, where a heat source in the vicinity of the active region of the waveguide device is used to change the temperature and thus select an index change and affect the operation of the device. The optical behavior of these devices is simply determined by the refractive-index distributions generated. It should be recognized that it would be readily apparent to those skilled and experienced in these technologies that the devices and structures described in this teaching can be applied in substance to electro-optic and other methods of stimulating the appropriate refractive-index profiles. Devices described below in accordance with the principles disclosed herein have the potential advantage over conventional Mach-Zehnder devices in having smaller size, and thus greater integratability. Devices described below also have an advantage over discrete mechanically-adjusted variable attenuators in being integratable with other devices such as arrayed waveguide grating (AWG) multiplexers.

It should be noted that these optical devices are transparent and reciprocal. This means that they can perform their functions on optical signals propagating from left-to-right as drawn or from right-to-left as drawn. It is however customary to specify the function of the device to operate on signals travelling from left-to-right. The waveguides conveying the signal to the device from the left are referred to as the “input” waveguides, while the waveguides conveying the signal away from the device towards the right are referred to as the “output” waveguides. The following descriptions will conform to this custom, but it should be kept in mind that in actual operation optical signals may be intended to traverse the device in either or both directions.

An exemplary embodiment of this invention is represented in cross-sectional view in FIG. 1. It is made by first creating a silica waveguide using the following process: An undoped SiO₂ silica lower cladding layer 101, typically 15-30 μm thick, is deposited or oxidized on a silicon substrate 102. This lower cladding layer has a refractive index of approximately 1.4450. A core layer is then deposited on top of the lower cladding, using standard silica deposition techniques such as flame hydrolysis or plasma-enhanced chemical vapor deposition (PECVD). This core is silica with a dopant such as germanium or phosphorus, and has refractive index approximately 0.5% to 1% higher than the cladding index. The core layer is approximately 5-8 μm thick. The core layer is patterned using photolithography and reactive ion etching, often incorporating an intermediary hard mask layer such as chrome, to define a waveguide core of rectangular cross section 103. After the core is etched, a silica upper cladding layer 104 is deposited on the structure. An optional upper cladding layer has the same refractive index as the lower cladding layer, and is created in either doped or undoped silica. The waveguide is preferably designed to be single-mode, although the principles described herein can also be extended to multi-mode operation.

In this particular embodiment, the thickness of this top cladding is chosen to be sufficiently thin (approximately 0-5 μm 105 above the top of the waveguide core) that light can couple from the waveguide mode to an optical polymer coupling layer 106 placed above the cladding. The thickness of the layer is also selected to provide a desired amount of the power of the optical signal in the polymer layer, based on a desired amount of attenuation and also based on a desired amount of attenuation with change in temperature. The coupling layer can be in direct contact with the core, but is preferably separated from the core by a portion of the upper cladding layer to reduce loss that may be incurred at the potentially rough interface between the waveguide and coupling layer materials. This coupling layer can be applied on the standard waveguide using spin coating, draw coating, sputtering, or other methods. In any case, the coupling layer is preferably integral with the upper cladding layer or with the core material. In addition to the classes of suitable polymers mentioned herein, examples of suitable commercially-available material for this coupling layer include epoxies such as Epo-Tek OG 175, OG125, and OG 195, available from Epoxy Technology, Billerica, Mass., and/or blends of these materials. The waveguide materials and coupling layer material have different thermal response, described by the quantity dn/dT which is the change in refractive index when the material undergoes 1° C. temperature change. In this example, the silica waveguide core and cladding materials have dn/dT of approximately 2×10⁻⁵/°C., and the polymer coupling layer has a dn/dT of approximately −2.5×10⁻⁴/°C.

Two thin-film metal resistive heaters 107 are patterned over the silica waveguide before depositing the polymer, one heater on each side of the waveguide, to provide local heating such that the temperature of the polymer and waveguide in the vicinity of the waveguide core can be increased. The polymer composition is chosen such that the refractive index of the polymer is equal to the refractive index of the silica cladding at a certain upper operating temperature, e.g. 55° C. At and above this temperature, the light is well confined in the waveguide. Also at and above this temperature the loss of this device is low, being the sum of the very low loss incurred by the fraction of the optical mode that is in the silica waveguide, and the loss incurred by the (usually small) fraction of the mode that is in the polymer material. At a lower operating temperature, e.g. 40° C., the refractive index of the polymer is equal to or higher than that of the silica waveguide core. In this example, the polymer layer is quite thick (>500 μm), such that a continuum or near-continuum of radiation modes exists in the polymer layer. At this lower operating temperature, radiation modes exist in the polymer into which a significant fraction of the light in the waveguide mode can escape. Under these conditions, a significant amount of the light in the waveguide mode is coupled into the polymer, reducing the intensity of the waveguide mode, i.e. attenuating the light in the waveguide. At temperatures between this lower operating temperature and upper operating temperature, the amount of coupling and thus attenuation varies continuously. In operation, the substrate of the device is maintained at or below the lower operating temperature, to facilitate cooling the device. This is preferably achieved by attaching a Peltier-type thermoelectric device to the underside of the substrate.

The design of the attenuator is carried out to minimize power consumption while achieving the desired dynamic range. There are several design considerations, and the particular choices are determined by how the device will be used. The attenuation rate at any given operating point (e.g. temperature) is determined by the size and position of the various layers of the waveguide and coupling layer, and the refractive index and loss of the materials at each point in the device. In practice, these distributions can be complex, and the exact magnitude of the attenuation rate is preferably solved through computer simulation of the geometry, refractive indices, and absorption of the waveguide and coupling layer, and index change mechanism (e.g. thermal input) using commonly available photonic software such as BeamPROP, made by RSoft, Inc. of Ossining, N.Y. The maximum and minimum attainable attenuation rates are thus solved by computer based on the maximum and minimum refractive index excursions in the coupling layer. The maximum and minimum attenuation of the device are computed as the maximum and minimum attenuation rates, respectively, multiplied by the length of the device.

One important design parameter is the amount of waveguide cladding, if any, that separates the waveguide core from the coupling layer, referred to herein as the separation cladding. The maximum attainable attenuation rate depends most strongly on the overlap of the waveguide mode with the coupling layer. A thicker separation cladding will result in smaller overlap of the waveguide mode in the coupling layer, and thus a smaller maximum attainable attenuation rate. Most materials that can be used for the coupling layer, e.g. polymers, have a non-negligible absorption of light. This causes a loss to the waveguide mode which is proportional to the material loss multiplied by the overlap of the waveguide mode with this coupling layer, and ultimately contributes to the insertion loss of the device. There is also a certain amount of insertion loss associated with roughness on the surface between the coupling layer and the separation cladding or waveguide core. These two sources of loss are both reduced as the separation cladding thickness is increased. Thus there is a tradeoff between the maximum attainable attenuation rate and the insertion loss of the device that must be considered in designing the device.

An additional factor to consider in choosing the thickness of the separation cladding is the maximum attenuation rate attainable. If light from a waveguide mode enters a region where there is no guiding, for example, a region in which the refractive index of the waveguide core is the same as that of the waveguide cladding (and thus the structure is indistinguishable from a bulk volume of glass), the light will dissipate according to the well-known process of diffraction. This diffraction has a finite rate, that is, light cannot be completely dissipated in lengths on the order of the optical wavelength. This same principle applies to any of the attenuators discussed herein: even in the maximum attenuating state, the dissipation of light (or coupling of light out of the coupling layer and into the waveguide core) has a finite maximum rate. This maximum ultimately limits the maximum attenuation rate attainable by reducing the thickness of the separation cladding or eliminating it entirely. That is, as the separation cladding thickness is reduced, one reaches a point of diminishing returns in which larger gains in insertion loss caused by the processes mentioned above begin to outweigh the small gains in the maximum attenuation rate. So although it is possible to reduce the thickness of the separation cladding to zero, eliminating it entirely in practice is in many cases undesirable. Considering all these factors, in most cases described herein, the preferable thickness of the separation cladding is approximately 1-3 μm.

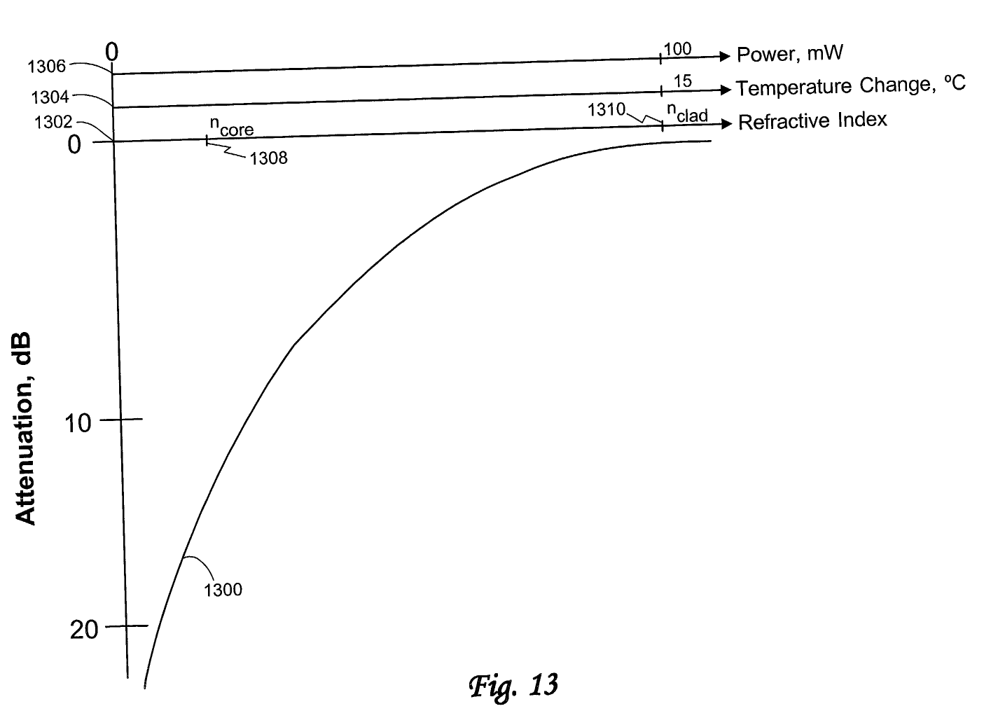

FIG. 13 is an example of the relationship seen in plot 1300 between the level of attenuation (in dB) and the refractive index of the coupling layer 1302. Also shown in this example is the average temperature change above the lower operating temperature, in °C., of the coupling layer 1304 near a waveguide core and the amount of input power 1306, in mW, applied to, e.g., adjacent heaters. As the amount of input power increases along axis 1306, the temperature of the coupling layer increases accordingly along axis 1304. Consequently, plot 1300 shows the decreasing attenuation level of a signal transmitted through the waveguide core with the increasing power and increasing temperature.

This decreasing attenuation level is also plotted against the average refractive index of the coupling layer near the waveguide core along axis 1302. As shown, as temperature of the coupling layer increases, the attenuation of the signal decreases as the refractive index in the coupling layer decreases. The area of immediate interest is preferably the attenuation which occurs between an upper limit and a lower limit, where an upper limit 1308 for the refractive index may be shown as the index of the waveguide core, n_{core}. Likewise, a lower limit 1310 for the refractive index may be shown as the index of the cladding immediately surrounding the core, n_{clad}. The attenuation is shown to vary smoothly between upper limit 1308 and lower limit 1310 as temperature and power is varied. That is, the attenuation displays a smooth and continuous transition between temperature and power extremes.

In the embodiment of FIG. 1, heat must be applied to the polymer or device to create low loss. In most cases, it is desirable to have sections of waveguide that do not require heat for low loss. For example, a practical attenuator will have optical fibers attached to the input and output of the waveguide. The mechanical fixturing required to mount optical fibers may make it impractical to have metal resistive heaters all the way to the edge of the chip. In this case, it is desirable to have the attenuator occupy a section in the middle of the chip, and waveguides that have low loss regardless of temperature at the edges of the chip. This need is further highlighted when integrating this invention with other devices such as switches on a single substrate. In such a case, the attenuator should be localized to certain desired areas of the substrate, and in other areas, low loss should be achieved regardless of temperature, i.e. without the need for heat input.

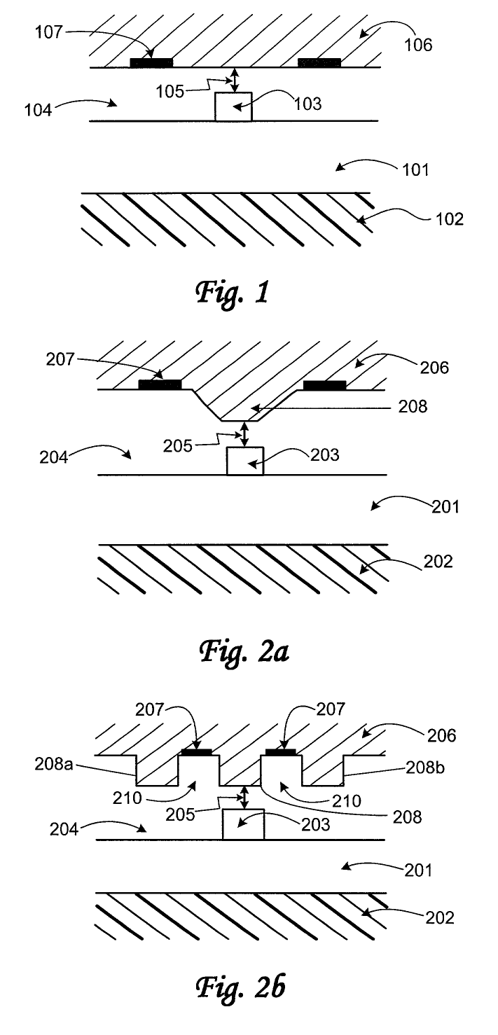

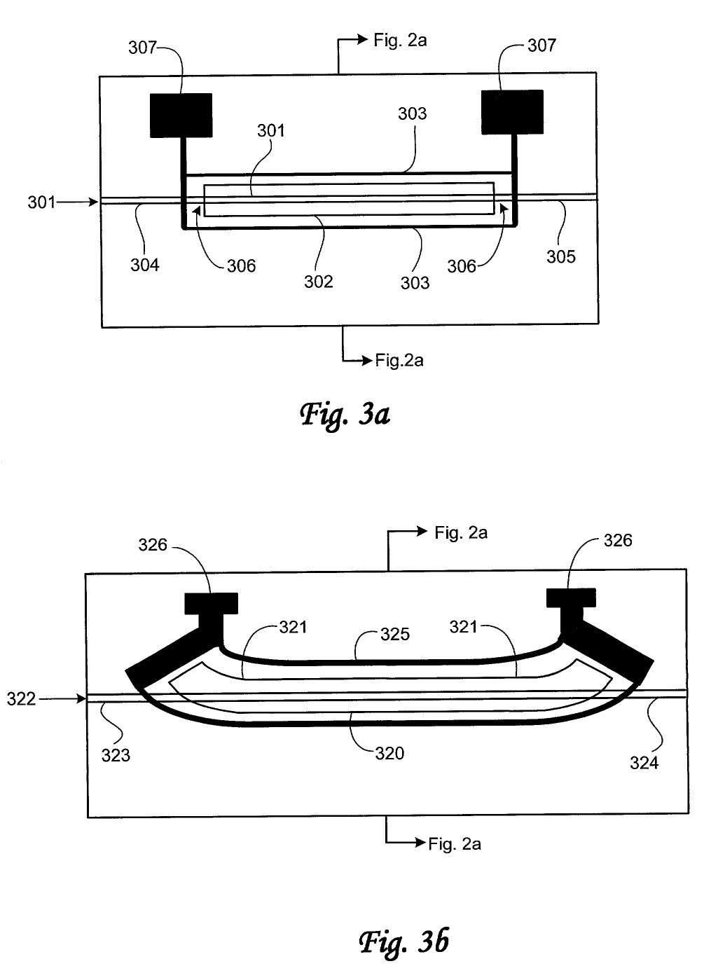

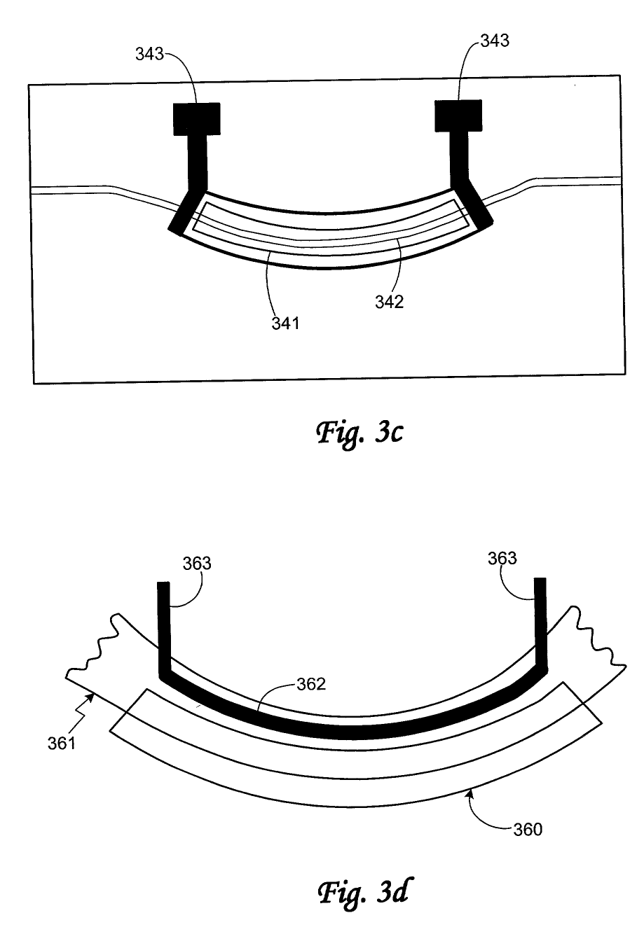

The embodiment of FIGS. 2a and 3a through 3d demonstrates one way in which this problem can be addressed. In the cross-sectional view of FIG. 2a, a silica lower cladding 201, and an etched silica waveguide core 203 are deposited on a silicon substrate 202 as described above. Lower cladding 201 preferably has a thickness ranging from about 5-30 μm while waveguide core 203 is preferably 6×6 μm in height and width and is further preferably doped, as discussed above, such that its refractive index is about 0.05 to 0.1 above that of lower cladding 201. In this case the silica upper cladding 204 is thicker (about 8-30 μm thick, but preferably about 10-15 μm above the waveguide core instead of the 0-5 μm of the device of the previous figure). Also, upper cladding 204 is preferably doped or undoped, as discussed above, such that its refractive index is at least about 0.02 below that of waveguide core 203, but preferably not below that of lower cladding 201. Again, the waveguide is preferably designed to be single-mode, although the principles described herein can also be extended to multi-mode operation. As illustrated in the figure, a well 208, which is preferably about 6-10 μm wide, is etched into this upper cladding using reactive ion etching (RIE) or a wet etch until preferably about 0-5 μm, but more preferably about 1-2 μm of upper cladding remain over the waveguide core. This thin remaining upper cladding 205 will serve as separation cladding, separating the waveguide core from the coupling layer. Thin-film metal resistive heaters 207 are applied on either side of this well and provide the heat necessary to control the attenuation of the device. Heaters 207 are preferably between about 5-10 μm in width, with a height which may be adjustable depending upon the desired amount of resistance. It is noted that for devices having low power consumption, temperature control may become more critical. A polymer coupling layer 206 like that presented for the embodiment of FIG. 1 is spin-coated to fill the etched wells and cover the top of the upper cladding. The device operates in the same manner as described for the embodiment of FIG. 1, giving a continuously-variable attenuation in response to heat applied by the resistive heaters. The walls of well 208 are preferably formed perpendicular to waveguide core 203 or to silicon substrate 202, although walls having a slight slant may be acceptable, as shown in the figure.

Another variation, which is similar to FIG. 2a, is shown in FIG. 2b but with the addition of two additional wells 208a, 208b. Additional wells 208a, 208b are preferably located adjacently on either side of well 208 such that resistive heaters 207 are located between 210 these wells on the upper cladding. These wells 208, 208a, and 208b may be used to define a heat path so that when heaters 207 are operating, the loss of heat outwards towards wells 208a, 208b is reduced. Having an efficient heat path defined may decrease the amount of power necessary to heat the device and therefore increase the overall power efficiency. Also, additional wells 208a, 208b are preferably similar in dimension to well 208 although they may also be of varying geometry, depending upon the desired attenuation result and heat path. Additional wells 208a, 208b are further preferably located equidistant from well 208, although these dimensions may also be varied depending upon the desired attenuation results and heat path.

FIGS. 3a through 3d show how this embodiment can be used to create an attenuator in selected areas of an otherwise non-attenuating waveguide chip. In FIG. 3a, the etched well 302 described in the embodiment of FIG. 2a is etched over the waveguide 301 only in a region in the center of the chip. Well 302 may range from 6-10 μm in width, as mentioned above, and may range from 500-1000 μm in length. FIGS. 3a through 3d show a single etched well over the waveguides for clarity, but these embodiments may easily be adapted to the variation shown in FIG. 2b having additional adjacent wells. Likewise, the heaters 303 are applied only in the region of this well. Heaters 303 may be connected to contact pads 307, to which wires may be bonded to for electrical contact to a voltage supply (which is not shown). This leaves input waveguide 304 and output waveguide 305 with unetched top cladding thus having the low loss that is characteristic of silica waveguides. The top of the chip over the well is coated with polymer as before, although the polymer layer is omitted from the figure for clarity. The top cladding layer is of sufficient thickness over waveguides 304 and 305 that the guided mode or modes of the optical signal do not appreciably extend into any polymeric layer deposited above these waveguides 304 and 305. Similar localization of the etched well can similarly be used when integrating devices to create an attenuator on a chip that also contains other waveguide devices such as optical switches. The depth, length, and position of the well as well as the refractive index, achievable change in refractive index, and change in refractive index with temperature are selected to provide the desired amount of attenuation and change of attenuation with change in temperature according to principles well-known in the art.

The etched well of the embodiments of FIGS. 2a and 2b can be configured in a number of ways. FIG. 3b shows a similar embodiment in which an etched well 320 is tapered at the ends 321 away from the waveguide 322. As before, the input 323 and output 324 waveguide benefit from low loss without thermal input, and metal resistive heaters 325 provide the heat necessary for operation. Heaters 325 may be electrically connected to contact pads 326 through which power may be supplied from a power source. Again, the polymer coating on the top of the chip is omitted in the drawing for clarity. This tapering of the well away from the waveguide reduces unwanted excess optical loss that may occur when the mode in the waveguide undergoes the abrupt transition from waveguides without wells to areas in which a well is etched, as depicted in 306 in FIG. 3a.

When light is guided around a curved waveguide, the mode is more weakly guided, and the position of the peak intensity of the mode is offset from the centerline of the waveguide core in the direction away from the center of curvature. This offset differs slightly for TE and TM polarizations. FIG. 3c depicts a curved well 341 that follows a curved waveguide 342. Heaters may be connected to contact pads 343 through which power may be supplied. In all other respects, this device is similar to the embodiment of FIG. 3a. This curved well has two main advantages. First, it can achieve a higher attenuation rate than straight wells, because of the weaker guiding of the mode in the curved waveguide. Higher attenuation rates per unit length of the well are desirable because a given dynamic range can be achieved with a shorter well, which requires less power to maintain at the upper operating temperature. Moreover, curved waveguide 342 allows for stray light removal from weakly guided modes. Second, it may be possible to affect PDL using the position of the well. For a given well position, the attenuation of the TE and TM modes may differ due to their differing positions relative to the waveguide core. The position of the well over the waveguide core can be shifted towards or away from the center of curvature, thus effecting a slight differential change in between TE and TM coupling. This change in coupling creates a change in the PDL of the device too better achieve a desired PDL, and preferably achieve a minimum PDL.

FIG. 3d illustrates two important principles. It depicts a curved well 360 as described in the embodiment of FIG. 3c, with the change that the well is shifted in position from the waveguide 361 away from the center of curvature for the purpose of affecting PDL, as described above. Also, because of the shift of the well away from the center of the waveguide, only one metal resistive heater 362 is necessary to provide heat in the polymer near the waveguide. Resistive heater 362 may be attached to contact pads 363 through which wires may be bonded for electrical contact. The use of a shifted well may also aid in reducing any stray light escaping from waveguide 361 from bouncing back directly into waveguide 361.

The embodiments of FIGS. 3a through 3d demonstrate only four of numerous possibilities of how a well of various shapes can be created in various positions relative to a waveguide to make a variable attenuator. It will be apparent to one of ordinary skill in this field that the principle of changing the attenuator geometry along the length of the waveguide can also be applied to all the other embodiments mentioned herein.

One potential problem with the embodiments above is that if the coupling layer is not sufficiently thick, a discrete set of modes may exist in the coupling layer. In such a case, light will only couple out of the waveguide mode if a mode of equal effective index exists in the coupling layer. In such a case, smoothly varying temperature-controlled attenuation may be hard to achieve. There are several solutions to this problem. If the coupling layer is sufficiently thick, and/or has a nonuniform top surface, the number of modes in that coupling layer becomes large, approaching a continuum, thus allowing coupling for any refractive index of the coupling layer at or above the waveguide effective index.

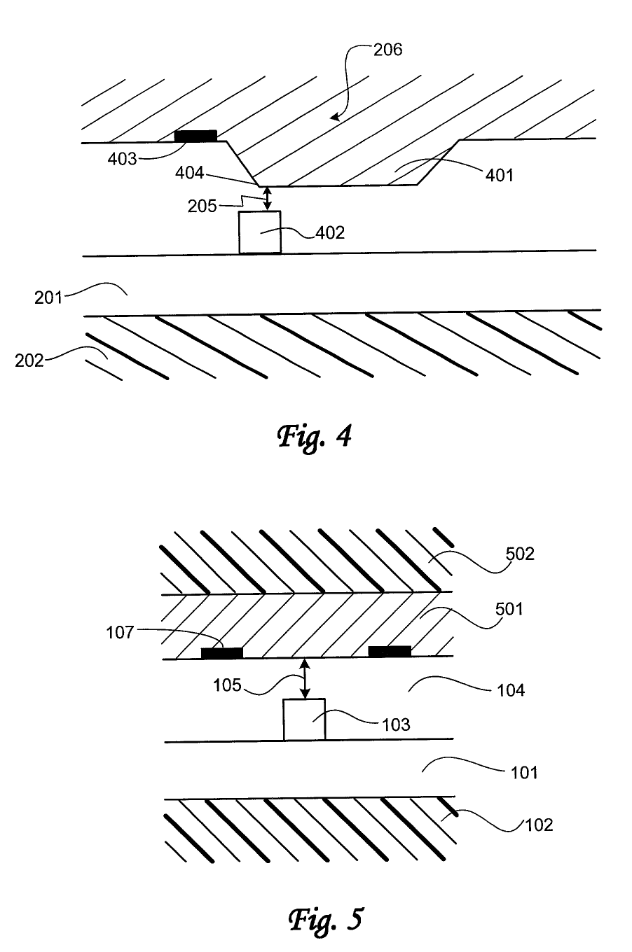

Another solution to this problem is to create a structure which has a more continuous set of modes. In the embodiment pictured in cross-sectional view in FIG. 4, a wider well 401 is used, extending in one direction at least 10 μm away from the waveguide 402, and only one heater 403 is used. In other respects, the parts of the device are the same as FIG. 2a. This configuration has the advantage of only requiring one heater, potentially reducing the required power. In addition, this structure has a more continuous distribution of modes, aiding in avoiding the problems discussed above arising from a coupling layer with a finite number of modes. The edge 404 of the lowest face of the well can be at any position relative to the waveguide, including centered over the waveguide, or to either side of the waveguide. However, to have efficient heating, it is desirable to have the single heater near or on top of the waveguide. Thus it is preferred to have this edge of the well approximately over the waveguide. The exact position can be adjusted to achieve the desired attenuation rate.

Another solution to the problem of discrete modes in the coupling layer is to add a high-index layer above the coupling layer, as shown in FIG. 5. At all temperatures in the operating range of the device, this second high-index layer has a refractive index higher than both the refractive index of the coupling layer and the effective index of the waveguide mode. Beyond this refractive index requirement, the thermal response of the refractive index of this layer has little effect on the operation of the device. Also, the absorption of light of this material need not be low. An example of this type of layer would be polyimide, with a refractive index about 1.6, or silicon, with a refractive index about 3.5, or bromonaphthalene liquid, with a refractive index about 1.6. If the high-index material has an appreciable change of refractive index with respect to temperature (as is the case for most polyimides), it is desirable that its refractive index be higher than the refractive index of the coupling layer and the effective index of the waveguide mode throughout the operating temperature range. It is preferred that the high-index layer be substantially greater (at least 0.1 greater) than these.

An embodiment based on this solution is presented in cross-sectional view in FIG. 5. This is largely the same as the embodiment of FIG. 1, with the exception that the polymer coupling layer 501 is reduced to approximately 10 μm thickness, and a thick (approximately >50 μm) high-index layer of silicon 502 is added above this. This can be achieved by bonding a silicon wafer to the coupling layer, potentially using the coupling layer polymer itself as an adhesive. Because the refractive index of the high-index layer is greater than that of the optical polymer coupling layer for all temperatures at which this device will operate in normal use, no modes exist in the optical polymer coupling layer. When the temperature is at an upper operating temperature such that the coupling layer is sufficiently below the effective index of the waveguide mode, very little of the waveguide mode extends through the coupling layer into the high-index layer, and thus little coupling to the high-index layer occurs, meaning the device has low loss. When the temperature is at a lower operating temperature such that the refractive index of the coupling layer is greater than or equal to the effective index of the waveguide mode, light is coupled into the coupling layer and then into the high-index layer, thus creating a device with high attenuation. As before, for temperatures between the upper operating temperature and the lower operating temperature, the attenuation varies in a continuous fashion. As in the embodiment of FIG. 1, thin-film metal resistive heaters are used to control the temperature and thus the degree of attenuation. It will be apparent to one skilled in the art that the high-index layer can also be applied to the embodiments of FIGS. 2a through 4. It will also be apparent that the high-index layer could be applied in selective areas similarly to the shaped well of FIGS. 3a through 3d.

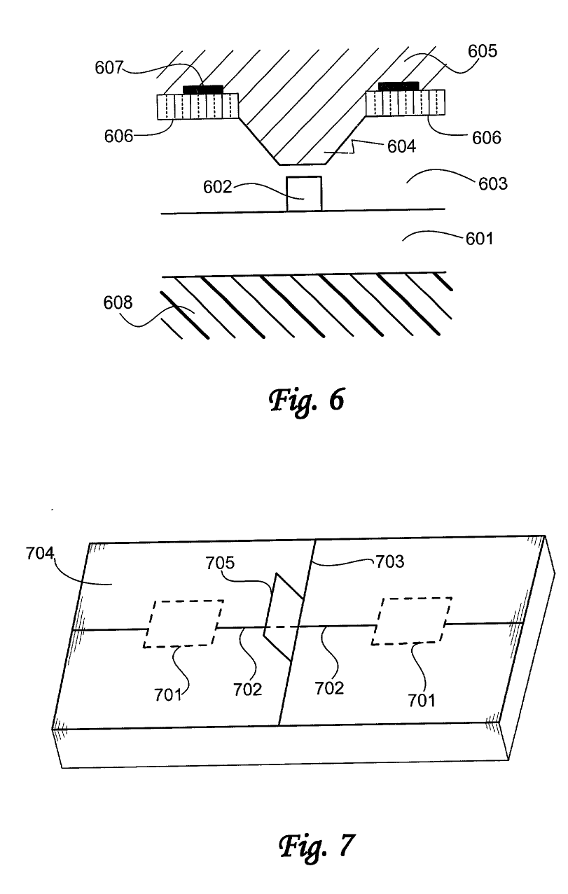

FIG. 6 shows a cross-sectional view of an embodiment similar in principle to that of FIG. 5, but which may be easier to fabricate in practice. It is based largely on the embodiment of FIG. 2a, with the addition of a high-index material. In this embodiment, a silica lower cladding 601, silica waveguide core 602, and silica upper cladding 603 are created on a substrate 608 as described above. On top of this structure, a layer 606 of amorphous silicon is deposited and patterned for use as a hardmask and as a high-index layer. This hardmask is used to etch a well 604 into the silica cladding, such that a polymer coupling layer 605 can fill this well and come into close proximity to the waveguide core. In this case, the amorphous silicon is not removed, but is left in place over the upper cladding (it may, however, be removed selectively from other non-attenuating areas of the device). Thin-film metal resistive heaters 607 are placed on the amorphous silicon layer before filling the well with polymer, and these heaters provide the thermal input necessary to control the device. Similarly to the embodiment of FIG. 5, the thermally-controlled refractive index of the polymer coupling layer determines how much light can couple out of the waveguide mode into the coupling layer, and subsequently into the amorphous silicon high-index layer. This high-index hardmask is subject to the same refractive index constraints as the high-index layer described in the embodiment of FIG. 5. The distance from the high-index material to the waveguide mode is preferably sufficiently great (approximately 10-15 μm) that when the coupling layer is equal to or less than the refractive index of the cladding, appreciable attenuation does not occur. The thickness of this high-index layer and its proximity to the waveguide core are selected to provide the desired amount of attenuation and change of attenuation with change in temperature according to principles well-known in the art.

The response of this attenuator for different polarizations of input light depends on the birefringence of the materials, including the waveguide core and cladding, the coupling layer, and the high-index layer if one is used. In some cases, the birefringence will be high enough that the two principle polarizations, TE and TM, will experience differing amounts of attenuation at the same thermal operating point. In this case, the attenuator will have undesirable non-zero polarization dependent loss (PDL). The embodiment pictured in FIG. 7 reduces unwanted PDL. Two variable attenuators 701 of the type pictured in FIG. 3a, and more preferably of the type pictured in FIG. 2b, are placed symmetrically on either side of a non-attenuating section of waveguide 702. Such a device may be expected have a power consumption of about 100 mW. A thin groove 703 is cut partway into the substrate 704 in the center of the waveguide using a dicing saw, laser ablation, or etch, and a half-waveplate made from stretched birefringent polymer 705 is placed in the groove with its principle axis oriented 45 degrees to the plane of the substrate. Light that enters the waveguide in the TE mode is converted to the TM mode at this waveplate, and light that enters in TM is converted to TE. Because of the symmetry of the device, light entering the device in either the TE or TM polarization experiences the same cumulative loss. Light of any input polarization can be broken down into the superpositions TE and TM light, meaning that input light of any polarization experiences the same loss. PDL is thus significantly reduced or eliminated, limited by any asymmetries in the device and the efficiency of the waveplate. Analogous embodiments for other optical devices are described in U.S. Pat. No. 5,901,259, U.S. Pat. No. 5,694,496, European Patent 623,830, Japanese Patent 7,092,326, and Japanese Patent 4,241,304, each of which is incorporated by reference herein.

### FURTHER DESCRIPTION OF THE INVENTION AND THE PREFERRED EMBODIMENTS

It should be clearly appreciated that most of the characteristics of silica being exploited would be applicable to a large variety of other inorganic and organic dielectric waveguide materials including, for example, lithium niobate and other crystalline or polymer optical structures suitable for fabricating integrated photonic devices. Consequently, structures fabricated using these optical materials are also within the scope of this invention, although silica is preferred. The operation of the device depends on having a coupling layer whose refractive index can be changed relative to the effective index of the waveguide, and can be extended beyond the specific examples cited here. Several examples of further embodiments of the invention are provided below.

A first further embodiment of a device of the invention is to use a sol-gel waveguide instead of a silica waveguide in the variable attenuator. In this embodiment, a layer of sol-gel produced glass is used as a lower cladding. A core layer of sol-gel glass is deposited on the lower cladding, and etched using reactive ion etching (RIE) to define a waveguide core with an approximately rectangular cross-section. Alternately, an ultraviolet light-definable sol-gel process can be used such that the rectangular cross-section core can be photolithographically exposed directly into the core layer of sol-gel glass. After the core layer is defined, an upper cladding layer can be defined also using standard sol-gel processing. At this point, variable attenuators analogous to any of the embodiments mentioned above can be created using sol-gel glass waveguides instead of the silica waveguides mentioned.

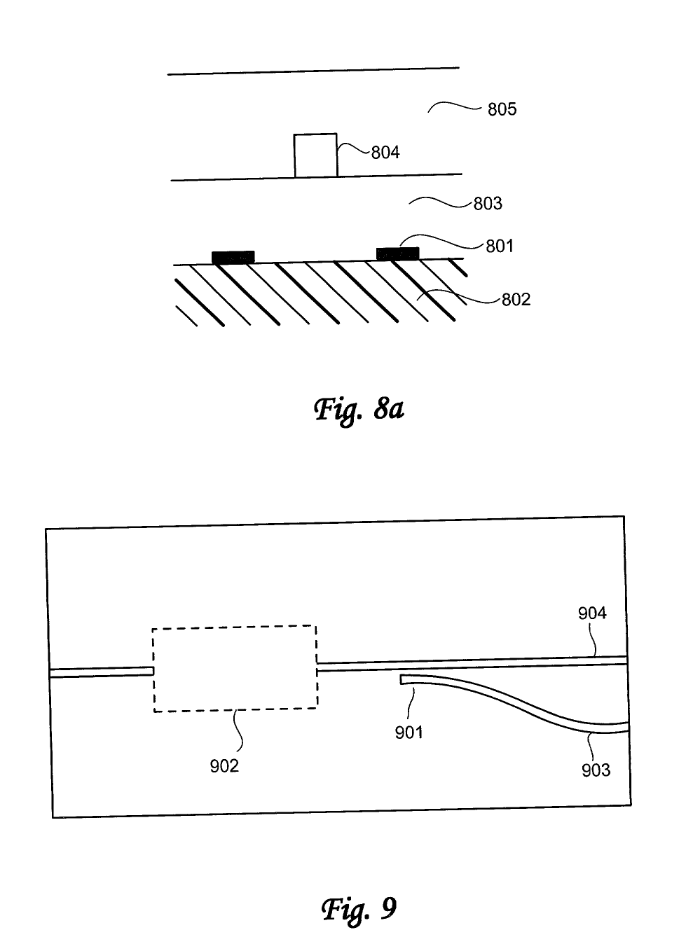

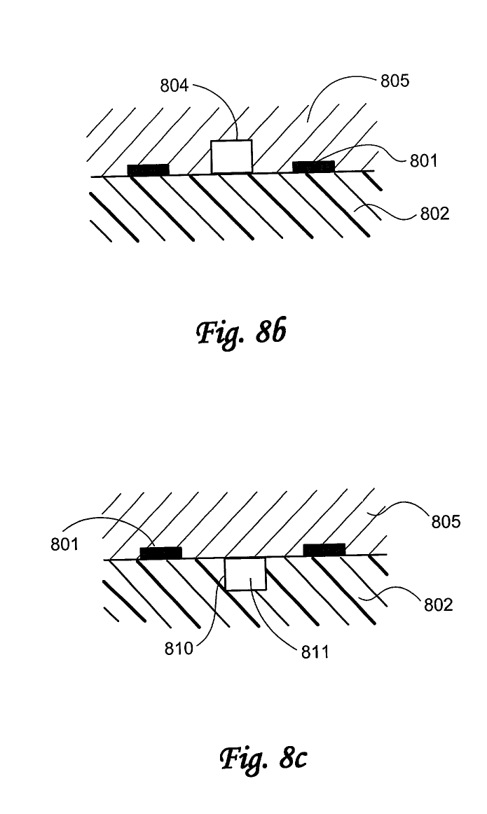

A second further embodiment of a device of the invention is the use of a silica coupling layer with a polymer waveguide. FIG. 8a shows a cross-sectional view of a polymer waveguide on a silica substrate. The polymer waveguide is formed as follows: Metal heaters 801 are placed on the silica substrate 802. A lower polymeric cladding layer 803 about 10 μm thick is spin-coated on the silica substrate. At the lower operating temperature of the device, the polymer cladding layer has a refractive index of 1.445, approximately equal to that of the silica substrate. A polymeric core layer with refractive index approximately 1% higher than the lower cladding layer is then spin-coated on top of the lower cladding. The core layer is etched using reactive ion etching to define a waveguide core with an approximately rectangular cross-section 804. A polymer upper cladding layer 805, with refractive index the same as the lower cladding layer, is then spin-coated over the waveguide core. At this lower operating temperature, the effective index of the waveguide mode is thus greater than the refractive index of the silica substrate, and the attenuator is in a minimum-loss state. The heaters can be used to supply heat to the structure, changing the refractive index of both the core and cladding of the waveguide, and thus changing the effective index of the waveguide mode. At the upper operating temperature, the effective index of the waveguide mode is below the index of the silica substrate, and light is coupled out of the waveguide into the substrate, and thus a maximum-attenuation state is reached. As before, at temperatures between this upper and lower operating temperature, the attenuation varies smoothly between this maximum and minimum value. Another variation of this embodiment is presented in FIG. 8b. This embodiment is similar to that of FIG. 8a with the omission of the lower polymeric cladding layer. Despite this omission, the device performs in an analogous way. A further variation is presented in FIG. 8c. In this device, a well 810 is etched into the silica substrate 802. This well is filled with a polymer waveguide core 811, with refractive index approximately 1% higher than that of the silica substrate. This core is applied by spin coating and planarizing using mechanical polishing. A polymer upper cladding layer 805 is then applied by spin coating, and two resistive heaters 801 are supplied as before. This device works in an analogous way to that presented in FIG. 8a. That is, when the polymer waveguide core refractive index is substantially above that of the silica substrate, little attenuation occurs. When the structure is heated such that the polymer waveguide core refractive index is below that of the silica cladding, the light is strongly attenuated. Between these two cases, the attenuation increases as the polymer waveguide core refractive index decreases.

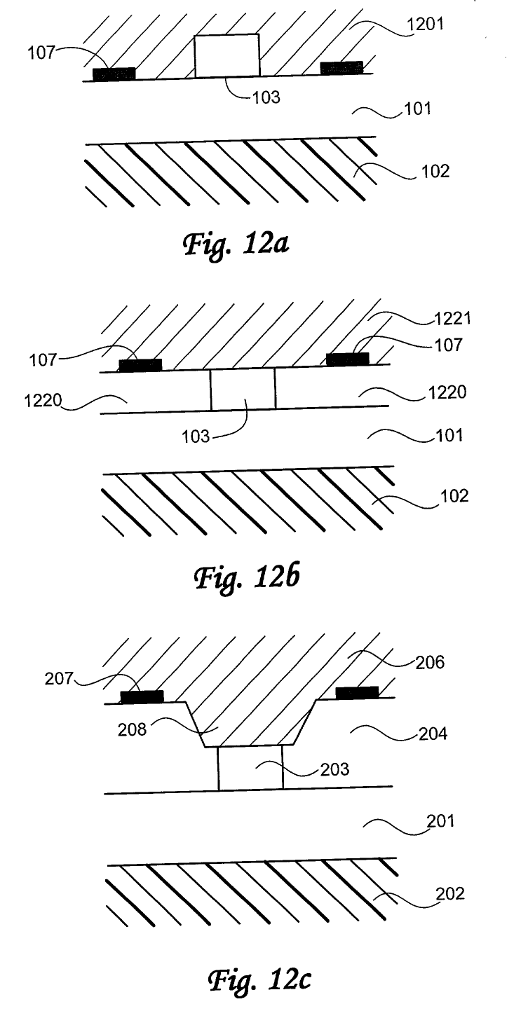

Another set of further embodiments of a device of the invention is to eliminate the thin cladding layer that separates the coupling layer from the waveguide core. FIG. 12a presents a modification of the embodiment of FIG. 1 in which silica upper cladding 104 is entirely replaced by the coupling layer material 1201. FIG. 12b shows a cross-sectional view of a device which has a silica cladding 1220 beside the waveguide core, but no silica cladding above the waveguide core. The polymer coupling layer 1221 is directly above the waveguide core. FIG. 12c presents a cross-sectional view of an embodiment which is a modification of that of FIG. 2a. In this embodiment, the well is etched until no upper cladding remains directly above the waveguide core. It is even possible to etch away part of the waveguide core, reducing its total height. All three of these devices performs in a way analogous to the embodiments of FIGS. 1 and 2a. That is, when the coupling layer has a refractive index substantially less than that of the waveguide core, little attenuation occurs, and when the coupling layer has a refractive index equal to or greater than that of the core, the mode is attenuated strongly, and in between these two cases, the attenuation increases as the coupling layer refractive index increases.

The operation of this variable attenuator depends on having a mechanism by which the refractive index of the coupling layer can be changed relative to the effective index of the waveguide. It will be evident to one skilled in the field that many different mechanisms of refractive index change will meet this need. Mechanisms that can be used to create refractive index changes in a coupling layer include a thermo-optic polymer that changes refractive index in response to a heat stimulus; an electro-optic polymer that changes refractive index in response to an electric-field stimulus generated by e.g. electrodes; a photo-elastic material that changes refractive index in response to a strain stimulus as applied by e.g. a piezoelectric micrometer driver, solenoid, or hydraulic ram having short throw to induce strain in the material; a piezo-optic material that changes refractive index in response to a strain stimulus; a liquid crystal or liquid crystal polymer that changes refractive index in response to an applied electric field; and a photo-refractive material that changes refractive index in response to an optical-field stimulus such as lasers or other devices emitting light of the appropriate wavelength.

The preferred heat source in the thermo-optic structures of the invention is a thin film or electrode heater deposited by e.g. sputtering the appropriate material on or near the coupling layer. Other heat sources may, of course, be used and include lasers or light-emitting diodes emitting infrared radiation as well as radiative heaters or thermoelectric devices positioned above, on, or near the thermo-optic polymer. The heater may be separate from the integrated photonic device, although preferably the heater is formed as part of the integrated device. For the examples given herein, thin-film resistive heaters are used. Although heater have been presented at specific locations on the device in the figures, it is important to note that numerous possibilities exist for positioning heaters near the waveguide and coupling layer. For example, it is possible to modify the embodiment of FIG. 1 to have the heaters on top of the polymer coupling layer, although it is preferred to have the heaters on the surface of the oxide waveguide, as presented in the figure.

Typical applications of this invention to further known waveguide devices are described subsequently. Most of the described devices are suitable for many different configurations of the detailed embodiments and the possible combinations are quite numerous. The following examples are only a small sampling of some of the combinations that may be employed. Although individual devices are described, it should be apparent that the same applications could be made to multi-device circuits and arrays by placing multiple elements within the active regions and/or using multiple active regions on a single substrate.

This device can be used in different ways. In one mode of operation, the “variable attenuator,” continuously-variable loss is achieved by carefully controlling the amount of stimulus applied to the device to vary the refractive index of the coupling layer continuously between a maximum and minimum desired value. In the case of thermo-optic variable attenuators, this means operating within a temperature range in which these refractive indices are achieved. In this mode of operation, it is preferred that PDL remain low (often <0.5 dB) throughout the attenuation range. In another mode of operation, the “optical shutter,” the device is used with the refractive index of the coupling layer in two separate ranges, corresponding in the thermo-optic case to two temperature ranges. Within one refractive index range, the device will have minimum loss (the insertion loss) and in the other refractive index range, the device will have maximum loss. This can be used to selectively and controllably switch on or off an optical signal. In the optical shutter mode of operation, it is usually desirable to have as great a maximum loss as possible (perhaps 50-80 dB) and high PDL (about 1-10 dB) is more acceptable. It will be apparent to one skilled in this field that all of the devices described herein, although described in the variable attenuator mode of operation, can also be used or configured to operate in the optical shutter mode of operation.

In practical application of variable attenuators to optical communication systems, it is often desirable to measure the optical power before and/or after the attenuator. For example, given a varying input optical power, a fixed output optical power can be attained by measuring the optical power at the exit of the attenuator, and using the measured value to calculate how the attenuator should be adjusted. This type of functionality can be enabled by providing a power splitter integrated on the same substrate as the variable attenuator to split off a small fraction of the optical power for monitoring before and/or after the variable attenuator. FIG. 9 illustrates schematically a case in which a splitter 901 is created on the same substrate as a variable attenuator 902. The splitter redirects a small fixed fraction (about 1%) of the light exiting the variable attenuator into a separate waveguide 903. The light from this waveguide is sent to a detector and the resulting signal used in a feedback circuit to adjust the heat or other stimulus controlling the extent of attenuation until the desired output optical power at the output port 904 is achieved.

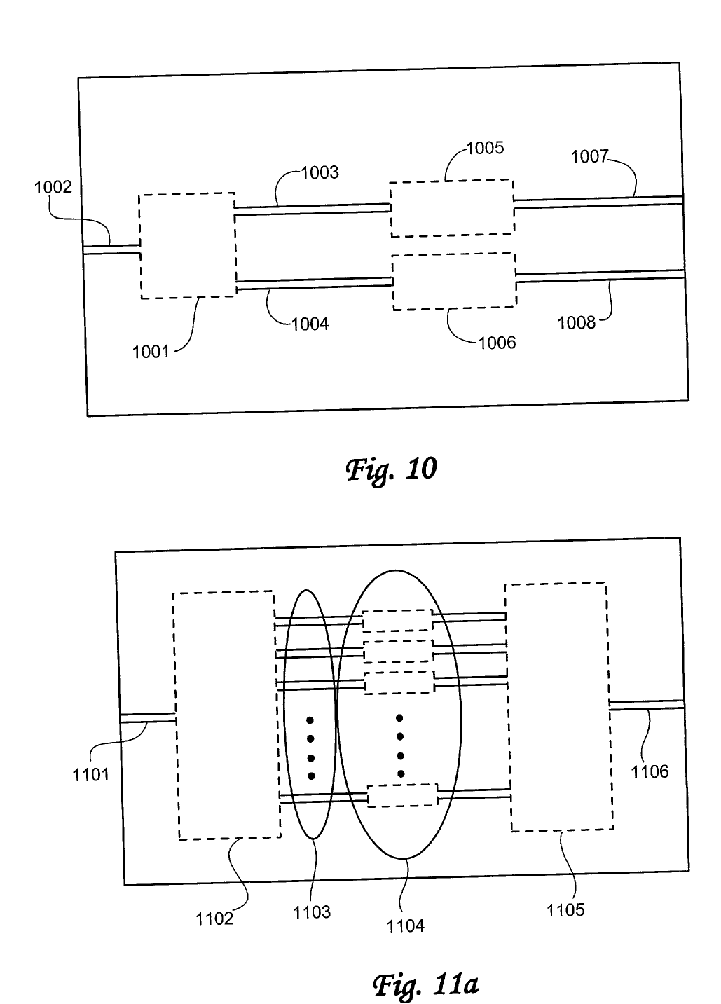

One performance issue in optical switches is the isolation, or the ratio, in dB, of the optical power exiting the desired output port to that of the optical power exiting from the undesired output port. Practical PLC optical switches in silica typically have 20-30 dB isolation. When combined with variable attenuators used as optical shutters as illustrated in FIG. 10, the isolation can be increased using these high-extinction optical switches. The figure depicts an optical switch 1001. The optical switch can be of any variety, for example a 1-input 2-output Mach Zehnder switch. This switch directs light from the input 1002 into the desired switch output, either 1003 or 1004. If the switch is set to direct light into 1003, then the isolation of the optical switch 1001 is the logarithmic ratio of the power at 1003 to the unwanted power at 1004, usually about 30 dB for typical switches. To improve this isolation, attenuator 1005 connected to 1003 is set for minimum loss (near 0 dB), while the attenuator 1006 on the undesired output 1004 is set for maximum attenuation (e.g. 30-50 dB). The isolation for the combined switch/shutter is now the logarithmic ratio of the power at 1007 to the power at 1008, and is increased to 50-80 dB. High extinction in the other switched state (where the majority of the power is directed to 1004 and then 1008) can be achieved analogously. One skilled in the art will readily appreciate that this concept can be used with PLC switches of nearly any type (Mach-Zehnder, directional coupler, y-branch, etc.), and of any number of input and output ports (1×2, 1×8, 2×2, 64×64, etc.).

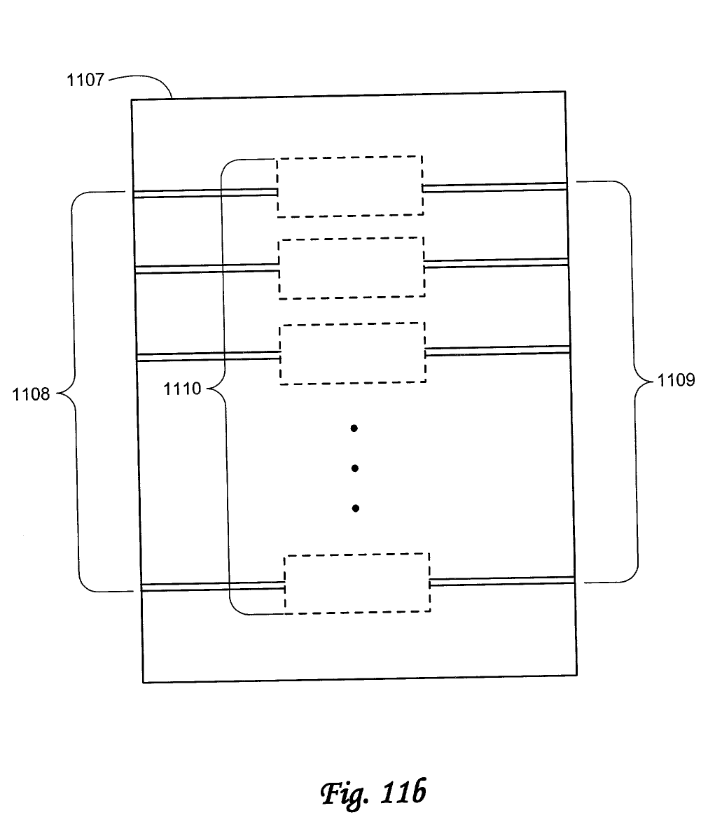

In communications systems employing a multiplicity of wavelength channels, it is often desirable to adjust the optical power in each wavelength channel independently. The variable attenuators of this invention, when combined in an array with an Arrayed Waveguide Grating (AWG) wavelength multiplexer (MUX) and an AWG wavelength demultiplexer (DMUX), can be used to make a dynamic gain filter, as depicted schematically in FIG. 11a. A multiple-wavelength input signal at the input port 1101 enters an AWG DMUX 1102, which routes the individual wavelength channels into separate waveguides 1103. A number of variable attenuators 1104, one attached to each waveguide 1103, adjusts the optical intensity of each channel before an AWG MUX 1105 is used to recombine the signals to the output 1106 of the device.

Another preferable embodiment is shown in FIG. 11b. Substrate 1107 embodies a monolithically integrated VOA array which may be fabricated according to any of the methods described above. This embodiment is comprised of a series of input waveguides 1108 which lead to corresponding attenuators 1110. Input signals would enter the VOA array individually through each input waveguides 1108 and then enter attenuators 1110. Attenuators 1110 may be any of the attenuators as described herein, but are preferably of the type as shown in FIG. 2a, and more preferably of the type as shown in FIG. 2b. Once the individual signals enter attenuators 1110, the signals may be attenuated accordingly. Subsequently, the signals may then exit attenuators 1110 through output waveguides 1109.

We claim:

1. A variable optical attenuator for attenuating an optical signal, comprising:
an optical waveguide comprising a core and cladding; and,
an integrated coupling layer disposed adjacent to the optical waveguide, the coupling layer having a variable refractive index,
the attenuator being configured to stimulate at least the coupling layer via a contact such that the refractive index changes in response to a stimulus.

2. The attenuator of claim 1 wherein the optical waveguide comprises SiO₂.

3. The attenuator of claims 1 or 2 further comprising at least one resistive heater disposed adjacent to the coupling layer.

4. The attenuator of claims 1 or 2 wherein the stimulus comprises a type selected from the group consisting of electric fields, heat, dynamic stress, piezo-optic stress, static-stress, photo-refraction, and refractive index changes using liquid crystals.

5. The attenuator of claims 1 or 2 wherein the coupling layer comprises a polymer.

6. The attenuator of claim 5 wherein the polymer is selected from the group consisting of polyacrylates, polymethacrylates, polysilicone, polyimide, epoxy, polyurethane, polyolefin, polycarbonate, polyamides, polyesters, and blends and copolymers of acrylates and methacrylates, acrylics and silicones, epoxies and urethanes, and amides and imides.

7. The attenuator of claims 1 or 2 wherein the core has a refractive index about 0.5-1% higher than a refractive index of the cladding.

8. The attenuator of claims 1 or 2 wherein the core has a thickness of about 5-8 μm.

9. The attenuator of claim 8 wherein the core has a thickness of about 6 μm.

10. The attenuator of claims 1 or 2 wherein the core has a characteristic thermal response such that the core decreases in refractive index upon a decrease in temperature.

11. The attenuator of claims 1 or 2 wherein the cladding further comprises an upper cladding disposed above the core and a lower cladding disposed below the core.

12. The attenuator of claims 1 or 2 wherein the coupling layer directly contacts the core.

13. The attenuator of claim 11 wherein the upper cladding has a thickness less than about 5 μm.

14. The attenuator of claim 11 wherein the lower cladding has a thickness of about 15-30 μm.

15. The attenuator of claims 1 or 2 wherein the coupling layer comprises at least one well disposed above the core.

16. The attenuator of claim 15 wherein the well has a width of about 6-10 μm and a length of about 500-1000 μm.

17. The attenuator of claims 1 or 2 wherein the coupling layer has a characteristic thermal response such that the coupling layer increases in refractive index upon a decrease in temperature.

18. A variable optical attenuator system for reducing polarization dependent loss, comprising:
at least two variable optical attenuators as described in claims 1 or 2, each of the attenuators being disposed on a substrate and located symmetrically about a groove defined in the substrate, the attenuators being in optical communication with one another; and,
a waveplate disposed along the groove such that a signal passing between the two attenuators passes through the waveplate.

19. A combination variable optical attenuator system, the combination comprising:
at least one variable optical attenuator as described in claims 1 or 2, the attenuator being disposed on a substrate; and,
an optical device disposed on the substrate and in optical communication with the attenuator, the optical device being selected from the group consisting of optical switches, passive waveguides, arrayed waveguide grating wavelength multiplexers and demultiplexers, waveguide optical amplifiers, and optical waveguide splitters.

20. An array of variable optical attenuators comprising:
a plurality of input waveguides disposed in parallel on a substrate;
a plurality of attenuators, each as described in claims 1 or 2 and optically connected to a corresponding input waveguide; and
a plurality of output waveguides optically connected to a corresponding attenuator.

21. A controllable optical shutter comprising:
a variable optical attenuator comprising
an optical waveguide comprising a core and cladding and,
an integrated coupling layer disposed adjacent to the optical waveguide, the coupling layer having a variable refractive index,
the attenuator being configured to stimulate at least the coupling layer via a contact such that the refractive index changes in response to a stimulus,
the attenuator being configured to have an attenuation state comprising a maximum attenuation state and a minimum attenuation state,
whereby an optical signal is prevented from being transmitted through the attenuator in the maximum attenuation state, and
whereby the optical signal is transmitted through the attenuator in the minimum attenuation state.

22. A high-isolation optical switch comprising:
an optical switch; and
at least one controllable optical shutter as described in claim 21 optically connected to the optical switch.

23. A controllable variable optical attenuator for attenuating an optical signal, said attenuator having an optical waveguide made from similar core and cladding materials and a coupling layer in close proximity to the waveguide mode, and configured to provide a difference between the effective index of the waveguide mode and the refractive index of the coupling layer in proximity to the waveguide mode which can be modified such that, if the refractive index of the coupling layer is substantially lower than the effective index of the waveguide mode, minimal attenuation occurs to the light in the waveguide mode, and such that, if the refractive index of the coupling layer is substantially greater than the effective index of the waveguide mode, light is coupled into the coupling layer out of the waveguide mode to attenuate the optical signal, and such that for refractive index differences between these cases the amount of attenuation varies smoothly between this maximum and minimum value.

24. The attenuator of claim 23 wherein the optical waveguide comprises SiO₂.

25. The attenuator of claims 23 or 24 in which the attenuator has a source of thermal input that modifies the difference between the refractive index the coupling layer and the effective index of the waveguide mode.

26. The attenuator of claims 23 or 24 in which the coupling layer comprises a polymer.

27. A variable optical attenuator for attenuating an optical signal, comprising:
an optical waveguide comprising a core and cladding; and,
an integrated coupling layer disposed adjacent to the optical waveguide, the coupling layer having a variable refractive index and a characteristic thermal response such that the coupling layer increases in refractive index upon a decrease in temperature,
the attenuator being configured to stimulate at least the coupling layer via a contact such that the refractive index changes in response to a stimulus.

28. The attenuator of claim 27 wherein the optical waveguide comprises SiO₂.

29. The attenuator of claims 27 or 28 further comprising at least one resistive heater disposed adjacent to the coupling layer.

30. The attenuator of claims 27 or 28 wherein the stimulus comprises a type selected from the group consisting of electric fields, heat, dynamic stress, piezo-optic stress, static-stress, photo-refraction, and refractive index changes using liquid crystals.

31. The attenuator of claims 27 or 28 wherein the coupling layer comprises a polymer.

32. A variable optical attenuator for attenuating an optical signal, comprising:
an optical waveguide comprised of SiO₂, the waveguide comprising a core and cladding, the core and cladding having a variable refractive index; and,
an integrated coupling layer comprised of a polymer, the coupling layer disposed adjacent to the optical waveguide, the coupling layer having a variable refractive index,
the attenuator being configured to stimulate at least the coupling layer via a contact such that the refractive index changes in response to a stimulus.

33. The attenuator of claim 32 further comprising at least one resistive heater disposed adjacent to the coupling layer.

34. The attenuator of claim 32 wherein the stimulus comprises a type selected from the group consisting of electric fields, heat, dynamic stress, piezo-optic stress, static-stress, photo-refraction, and refractive index changes using liquid crystals.

35. The attenuator of claim 32 wherein the polymer is selected from the group consisting of polyacrylates, polymethacrylates, polysilicone, polyimide, epoxy, polyurethane, polyolefin, polycarbonate, polyamides, polyesters, and blends and copolymers of acrylates and methacrylates, acrylics and silicones, epoxies and urethanes, and amides and imides.

36. The attenuator of claim 32 wherein the core is doped with a dopant selected from the group consisting of Germanium, Phosphorus, and combinations thereof.

37. The attenuator of claim 32 wherein the cladding is undoped.

38. A method of attenuating an optical signal in a variable optical attenuator, comprising:
a) providing an optical waveguide comprising a core and cladding; and,
b) stimulating an integrated coupling layer disposed adjacent to the optical waveguide such that a signal in the core is attenuated via the coupling layer.

39. The method of claim 38 wherein the signal is attenuated by passing into the coupling layer.

40. The method of claim 39 wherein the signal passes into the coupling layer through the cladding layer.

41. The method of claim 39 wherein the signal passes directly into the coupling layer.

42. The method of claim 38 wherein the step of stimulating comprises a type of stimulation selected from the group consisting of electric fields, heat, dynamic stress, piezo-optic stress, static-stress, photo-refraction, and refractive index changes using liquid crystals.

43. The method of claim 42 wherein the heat stimulation is applied to the coupling layer through at least one resistive heater disposed adjacent to the coupling layer.

44. The method of claim 38 wherein the coupling layer comprises a polymer.

45. The method of claim 38 wherein the polymer is selected from the group consisting of polyacrylates, polymethacrylates, polysilicone, polyimide, epoxy, polyurethane, polyolefin, polycarbonate, polyamides, polyesters, and blends and copolymers of acrylates and methacrylates, acrylics and silicones, epoxies and urethanes, and amides and imides.

46. The method of claim 38 wherein the core has a refractive index about 0.5-1% higher than a refractive index of the cladding.

47. The method of claim 38 wherein the step of stimulating comprises stimulation of the core, which has a characteristic thermal response such that the core decreases in an effective index upon a decrease in temperature.

48. The method of claim 38 wherein the coupling layer has a characteristic thermal response such that the coupling layer increases in refractive index upon a decrease in temperature.
